(19) United States
(12) Patent Application Publication
(10) Pub. No.: US 2012/0097704 A1
(43) Pub. Date: Apr. 26, 2012

(54) LINEAR-DRIVE TOY WATER GUN

(75) Inventors: Lonnie G. Johnson, Atlanta, GA (US); John M. Baxley, Atlanta, GA (US)

(73) Assignee: JOHNSON RESEARCH AND DEVELOPMENT COMPANY, INC., Atlanta, GA (US)

(21) Appl. No.: 12/910,964

(22) Filed: Oct. 25, 2010

(51) Int. Cl. A63H 3/18; G01F 11/00; B65D 88/54

(52) U.S. Cl. 222/79; 222/333; 222/390

(57) ABSTRACT

A toy water gun has an energizable linear-drive piston mechanism selectively operable between anterior translational movement and posterior translational movement. The mechanism drives a piston assembly including a piston head within a piston housing to pressurize a piston chamber for impelling fluid therefrom. A discharge structure is in fluid-flow communication with the piston chamber. The mechanism includes a reversible, electric motor and an actuator switch for selectively actuating the reversible, electric motor.

### RELATED APPLICATIONS

Not applicable.

### STATEMENT REGARDING FEDERALLY SPONSORED RESEARCH OR DEVELOPMENT

Not applicable.

### TECHNICAL FIELD

This invention relates to toy water guns, more particularly, the invention relates to toy water guns having motorized, linearly-driven discharge systems.

### BACKGROUND OF THE INVENTION

Toy water guns are popular toys and have been popular for some time. Toy water guns project water, typically by means of pressurization of a compartment of water. Users of toy water guns typically desire to project a stream of water as continuously and as forcefully as possible the greatest distance possible. Users would like to achieve these objects with the greatest of ease. One method and apparatus utilizes a trigger pumping system in which a trigger that is engaged by a user's finger is a part of a pump mechanism that imparts pressure to a compartment of water in direct relation to each squeeze of the trigger. Once the water in the compartment is sufficiently pressurized, each subsequent squeeze of the trigger propels water from the gun. This type of toy water gun has limitations. For example, the length and duration of a stream of water that is propelled may be limited. One reason is that the distance and duration of a stream are directly linked to factors such as the amount and frequency of force that can be applied by the finger of a user and the maximum distance that a trigger can be engaged and squeezed. In addition, in order to generate a rapid series of individual shots or short spurts to create a continuous stream-like effect the user must apply multiple, successive squeezes to the trigger. This repetitive finger action is limiting in and of itself and also is tiring for the user.

Several patents disclose toy water guns that do not rely upon force-imparting finger action to discharge the gun. U.S. Pat. No. 4,706,848 discloses a battery-operated water gun that produces spurts corresponding to the action of a cam that drives a piston and wherein the cam is driven by a gear system. U.S. Pat. No. 4,743,030 discloses a water gun having a battery-operated pump that propels spurts of water.

Another approach to discharge systems for water guns has been use of a multi-step pressurization system wherein a compartment is first pressurized then, in a separate action, a trigger is activated to release water from the pressurized compartment thus “firing” the water gun. U.S. Pat. No. 5,074,437 discloses a toy water gun in which a water compartment is pressurized by a hand-operated pump that requires multiple hand and arm motions to operate. U.S. Pat. No. 5,586,688 discloses a toy water gun in which a battery-operated pump transfers water from a storage tank to a pressure tank where the water is held under pressure. U.S. Pat. No. 6,540,108 discloses a toy water gun in which a hand pump moves water from a storage tank to an expandable pressure tank that has an elastic bladder as a mechanism for retaining water under pressure. The multiple steps and effort required to fill and pressurize the tank of the aforementioned disclosures is a shortcoming that limits the usefulness and enjoyment of these types of toy water guns.

The motorized toy water guns described above produce short periodic squirts of water and they do not shoot very far. In a piston-system water gun, the problem of limited range is compounded due to the varying velocity of the water stream created by the cyclic motion of the piston. In these guns, the rotating shaft of the motor is coupled (usually by a gear mechanism) to a moment arm or flywheel, which is in-turn coupled to a piston that is mounted inside of a cylinder. Rotation of the motor causes the arm to move the piston linearly back and forth in a sinusoidal velocity cycle within the cylinder. The sinusoidal pumping action results in a continuously varying velocity of the water being drawn into and expelled from the cylinder. An initial burst of water is typically closely followed by bursts of water traveling at a higher velocity. This difference in velocity typically results in a disrupted flow that diminishes a stream effect. With the loss of the water stream effect, the individual droplets loose momentum quicker as they travel through the air.

Thus it can be appreciated that it would be useful to have a toy water gun that is capable of quickly and easily propelling a continuous stream of water a substantial distance in a manner that does not require undue exertion by a user, and particularly in a manner that does not require substantial finger or arm exertion by a user. It can further be appreciated that it would be useful also to have such a toy water gun that can be quickly and easily filled with water in preparation for discharge.

### SUMMARY OF THE INVENTION

According to an embodiment of the invention, a toy water gun has an energizable linear-drive piston mechanism selectively operable between anterior translational movement and posterior translational movement that drives a piston assembly within a piston housing to pressurize a piston chamber for impelling fluid therefrom. A discharge structure is in fluid-flow communication with the piston chamber.

In accordance with an aspect of the invention, the discharge structure is proximate either an anterior end or a posterior end of the piston housing

In accordance with an aspect of the invention, the discharge structure comprises a discharge aperture in a closed anterior end of the piston housing. In accordance with a feature of this aspect, the discharge structure further comprises a nozzle structure that terminates in the discharge aperture.

In accordance with an aspect of the invention, the discharge structure is in fluid-flow communication with either an anterior end or a posterior end of the piston chamber.

In accordance with an aspect of the invention, the energizable linear-drive piston mechanism further comprises a rotationally-driven, elongated, threaded drive shaft cooperatively engaged with the piston assembly so as to impart linear motion to a piston head. In accordance with a feature of this aspect, the rotationally-driven, elongated, threaded drive shaft is cooperatively engaged with the piston assembly by a thread follower. In accordance with another feature of this aspect of the invention, the thread follower is inhibited from rotational motion, such as by a detent.

In accordance with an aspect of the invention, the energizable linear-drive piston mechanism is driven by an electric motor. In accordance with a feature of this aspect of the invention, the electric motor has an actuator. In accordance with another feature of this aspect of the invention, the electric motor is reversible. In accordance with a further aspect of this feature, the reversible, electric motor has an actuator for selectively actuating the motor to turn in opposite directions.

In accordance with an aspect of the invention, the energizable linear-drive piston mechanism further comprises a rack-and-pinion assembly having a rack member connected with the piston assembly and a rotationally-driven pinion member cooperatively engaged with the rack member.

In accordance with an aspect of the invention, the piston chamber is closed at a posterior end and the discharge structure comprises a piston-discharge aperture formed in the piston head.

In accordance with an aspect of the invention, the water gun further includes mechanisms for filling the water gun including apertures, ports, conduits and valves, and a reservoir connected to an inlet port.

In accordance with an aspect of the invention, the discharge structure comprises a conduit extending from the housing terminating in a discharge opening. In accordance with a feature of this aspect, the discharge opening is proximate an anterior end of the housing. In accordance with another feature of this aspect of the invention, the discharge conduit further comprises a normally-closed valve disposed between the housing and the discharge opening operable to open when pressure at the piston chamber exceeds a predetermined level.

### BRIEF DESCRIPTION OF THE DRAWINGS

FIG. 1 is an isometric illustration of a toy water gun in accordance with an embodiment of the invention.

FIG. 2 is an isometric illustration of the toy water gun of FIG. 1 having a partial cut-away view of the housing and a portion of the piston assembly.

FIG. 3 is a circuit diagram of electrical components together with schematic representation of some of the mechanical components of the toy water gun of FIG. 1 wherein the piston is in a mediate refill position.

FIG. 4 is a circuit diagram of electrical components together with schematic representation of some of the mechanical components of the toy water gun of FIG. 1 wherein the piston is in full refill position.

FIG. 5 is a circuit diagram of electrical components together with schematic representation of some of the mechanical components of the toy water gun of FIG. 1 wherein the piston is in a mediate discharge position.

FIG. 6 is a circuit diagram of electrical components together with schematic representation of some of the mechanical components of the toy water gun of FIG. 1 wherein the piston is in a full discharge position.

FIG. 7 is an isometric illustration of a toy water gun having an attached reservoir in accordance with another embodiment of the invention.

FIG. 8 is a partial cut-way view of the toy water gun of FIG. 7 showing the piston in a mediate position.

FIG. 9 is another partial cut-away view of the toy water gun of FIG. 7 showing the piston in a fully retracted position.

FIG. 10 is a partial cut-away view of an isometric illustration of a toy water gun having a rack-and-pinion drive mechanism in accordance with another embodiment of the invention.

FIG. 11 is an isometric illustration of a toy water gun having a discharge aperture disposed within the piston head in accordance with an embodiment of the invention.

FIG. 12 is a sectional schematic illustration of a toy water gun having an external discharge conduit in accordance with an embodiment of the invention.

FIG. 13 is another sectional schematic illustration of the toy water gun of FIG. 12 wherein a valve mechanism of the discharge conduit has been engaged.

### DETAILED DESCRIPTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

As an overview, the invention teaches a toy water gun having an electrically-powered discharge system. The electrically-powered discharge system comprises an energizable, motorized linear-drive piston mechanism. In each of several embodiments a piston is linearly driven so as to impart an impelling force that pressurizes the piston chamber and discharge liquid from the gun through a discharge aperture or opening. The piston may be selectively forwardly driven or rearwardly driven. In some embodiments of the invention, liquid is discharged during a forward stroke. In other embodiments of the invention, liquid is discharged during a rearward stroke. In one embodiment a forwardly-driven piston discharges liquid through a discharge aperture disposed at the front of the piston chamber of the water gun. In another embodiment, the front of the piston chamber is open and liquid is discharged through a discharge aperture disposed in the piston itself as the piston is rearwardly driven. In another embodiment, liquid is discharged through a discharge opening that is disposed externally of the piston chamber and the housing that defines the piston chamber during a reward stroke of the piston.

Referring now to the drawings, wherein like numerals indicate like elements throughout the several views, the drawings illustrate certain of the various aspects of exemplary embodiments.

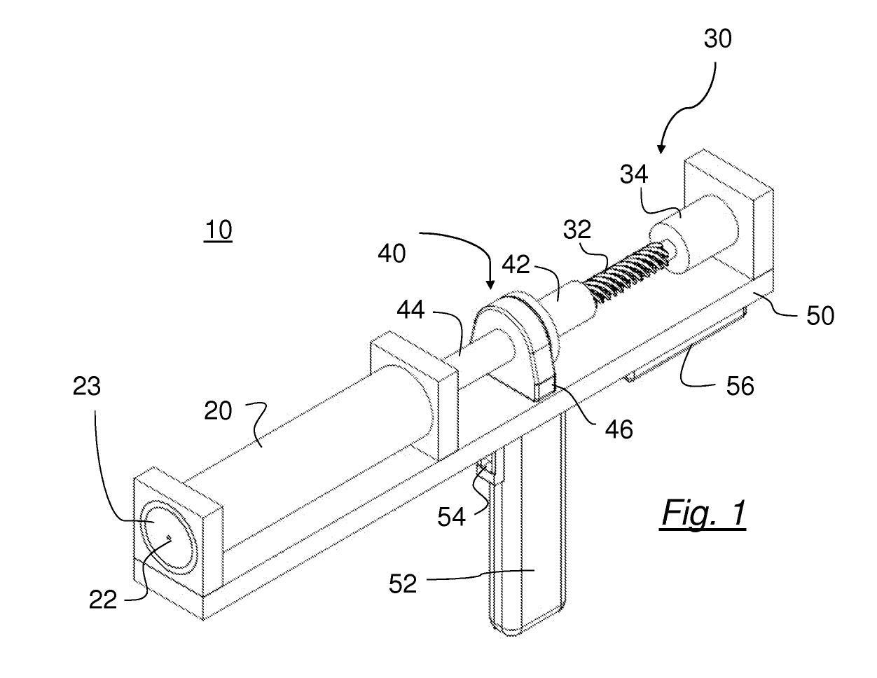

Referring first to FIG. 1, therein is shown a toy water gun 10 according to an embodiment of the invention. A piston housing 20 has an anterior end and a posterior end and defines an interior piston chamber (not visible in this view). A discharge aperture 22 is disposed at an anterior end of the piston housing 20. As such, it is in direct fluid-flow communication with the interior of the piston housing 20 (that is, the piston chamber, not seen in this view). The discharge aperture 22 is shown substantially centrally disposed in a closed anterior end 21 of the piston housing 20; however, as an alternative, the discharge aperture may be disposed in the closed anterior end 23 of the piston housing 20 at a location other than centrally disposed. As another alternative, the discharge aperture may be disposed externally of the piston housing 20 and placed in fluid-flow communication with the piston chamber such as through a conduit. An energizable linear-drive piston mechanism 30 is disposed for operable engagement with the piston housing 20. The energizable linear-drive piston mechanism 30 has an elongated, threaded, drive shaft 32 that is rotationally driven by a reversible DC motor 34. The elongated, threaded, drive shaft 32 is also known as a “drive screw” or “worm gear.” The elongated, threaded, drive shaft 32 is disposed to operatively engage and impart translational motion to a piston assembly 40. The piston assembly 40 has a thread follower 42 with a piston shaft 44 extending therefrom. The thread follower 42 may also be referred to as a “drive-screw follower.” As the elongated, threaded, drive shaft 32 rotates, the thread follower 42 will translate forwardly or rearwardly with respect to the elongated, threaded, drive shaft 32, depending upon the direction of rotation of the drive shaft 32. A detent 46 attached to the thread follower 42 and piston shaft 44 inhibits rotation of the thread follower 42 in order to more fully convert rotational force from the drive shaft 32 into translational motion of the thread follower 42 and associated piston shaft 44. The piston housing 20 and drive mechanism 30 are disposed upon a base 50 for support. A handle 52 provides a grasping mechanism for the water gun 10 and a trigger 54 disposed upon the handle 52 is an actuator, or switch, for the motor 34. The trigger switch 54 closes a circuit with a battery pack 56 that serves as the energy source. Sometimes for convenience the trigger/actuator/switch is referred to herein as a trigger switch 54.

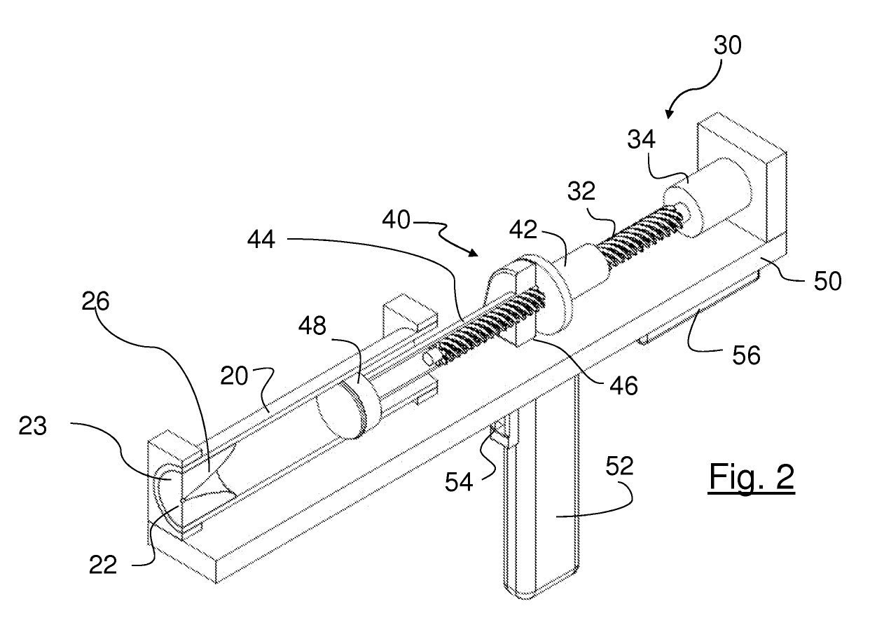

Referring now to FIG. 2, the toy water gun of FIG. 1 is depicted in a partial cut-away view of the piston housing 20 that reveals the piston chamber 24 that is defined by an interior surface of the piston housing 20. A piston head 48 is closely received by the piston chamber 24. Also shown in this view is an optional nozzle structure 26 disposed adjacent the discharge aperture. A partial cut-way view of the piston shaft 44 reveals that a bore is defined through the piston shaft 44 that slidably receives the elongated, threaded, drive shaft 32.

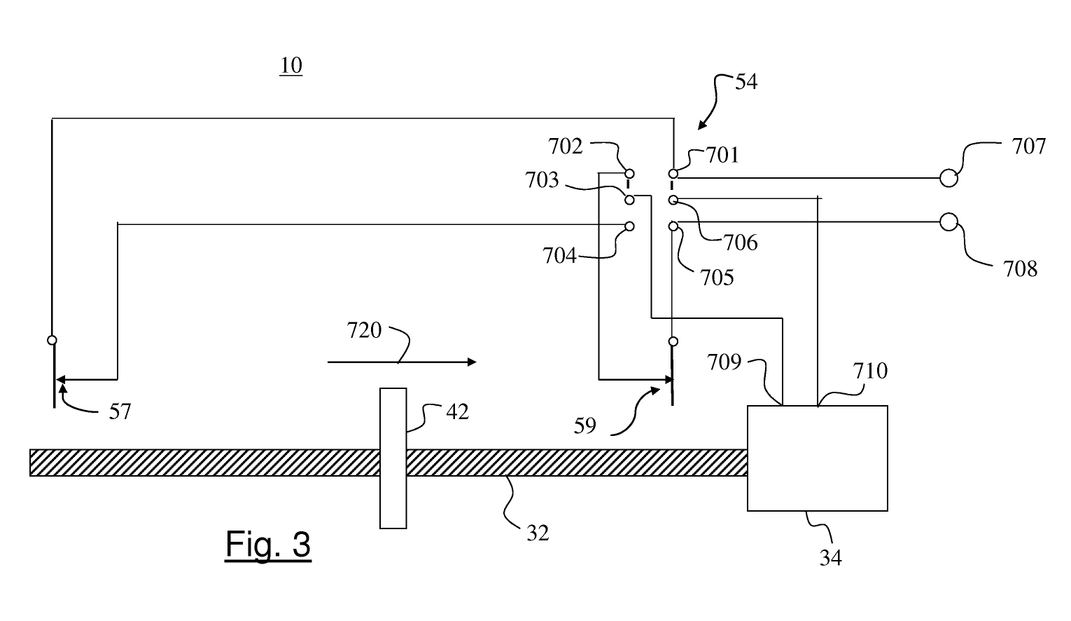

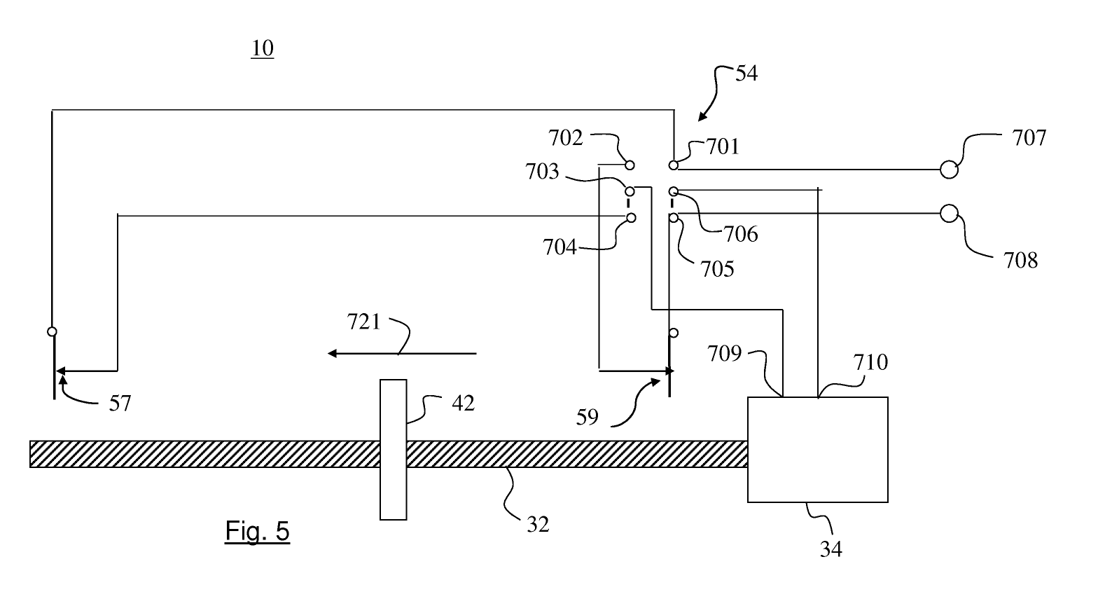

Now, referring generally to FIGS. 3 through 6, therein are shown combined schematic circuit diagrams and schematic representations of various mechanical elements including the elongated, threaded, drive shaft 32, the thread follower 42 and the motor 34. These figures illustrate the manner in which the thread follower 42 interacts with limiting switches 57, 59 to control travel of the piston head 48. Schematic representations of the trigger switch 54 are shown. Schematic representations of a forward limit switch 57 and a rear limit switch 59 are shown. The trigger switch 54 of the embodiment illustrated is a double-pole, double-throw switch that is capable of actuating a reversible motor 34. The trigger switch 54 is “double pole” in the sense that each setting of the switch controls two wires, or terminals. That is, when the switch is in an “on” position, there are dual points of contact. The switch is “double-throw” in the sense that it has two distinct “on” positions (with the “off” position not considered a separate “throw”). Referring to FIGS. 3 through 6 simultaneously, the trigger switch 54 has three sets of terminals, or poles, that are contacted in tandem. There is an uppermost set of terminals 701 & 702, a middle set of terminals 706 & 703, and a lowermost set of terminals 705 & 704. The designations uppermost, lowermost and middle are for convenience of explanation only. Uppermost terminal 701 is connected to one terminal 707 of the two battery terminals 707, 708. Lowermost terminal 705 is connected to the other terminal 708 of the two battery terminals 707, 708. The battery terminals have opposing positive and negative polarities. The polarity of each is not significant for the invention. It is only important that they are opposing. The two terminals 706 & 703 of the middle set of terminals are connected to respective terminals 710, 709 of the reversible DC motor 34. Reversing the polarity of the electricity applied to the motor 34 (through switch terminals 706, 703) will reverse the direction of rotation of the motor 34. One terminal of the forward limit switch 57 is connected to one trigger switch 54 switch uppermost terminal 701 that is also connected to a battery terminal 707. The other terminal of the forward limit switch 57 is connected to one of the lowermost trigger switch 54 terminals 704. One terminal of the rear limit switch 59 is connected to one trigger switch 54 lowermost terminal 705 that is connected to a battery terminal 708. The other terminal of the rear limit switch 59 is connected to the free terminal 702 of the uppermost pair of terminals. The resting (non-engaged) state of the trigger switch 54 is where the middle terminals 706, 703 are not in contact with either the uppermost set of terminals 701, 702 or the lowermost set of terminals 705, 704. The resting (non-engaged) position of each limit switch 57, 59 is normally closed as shown in FIGS. 3 and 5.

Referring now particularly to FIG. 3, therein is illustrated the electrical connection for rearward movement of the thread follower 42 (to which the piston head 48 is affixed). The uppermost set of terminals 701, 702 of the trigger switch 54 are contacted by the middle set of terminals 706, 703 to close a circuit that energizes the motor 34 thereby causing rotation of the drive shaft 32 in a first direction and associated rearward movement (the rear stroke) of the thread follower 42 (and thus the piston 48) as indicated by direction arrow 720. Battery terminal denoted 707 is connected to motor terminal denoted 710. And battery terminal denoted 708 is connected to motor terminal denoted 709. This circuit arrangement causes the motor to rotate in the first direction. The forward limit switch 57 is inoperable during rearward movement of the thread follower 42 because the circuit for that switch 57 is open.

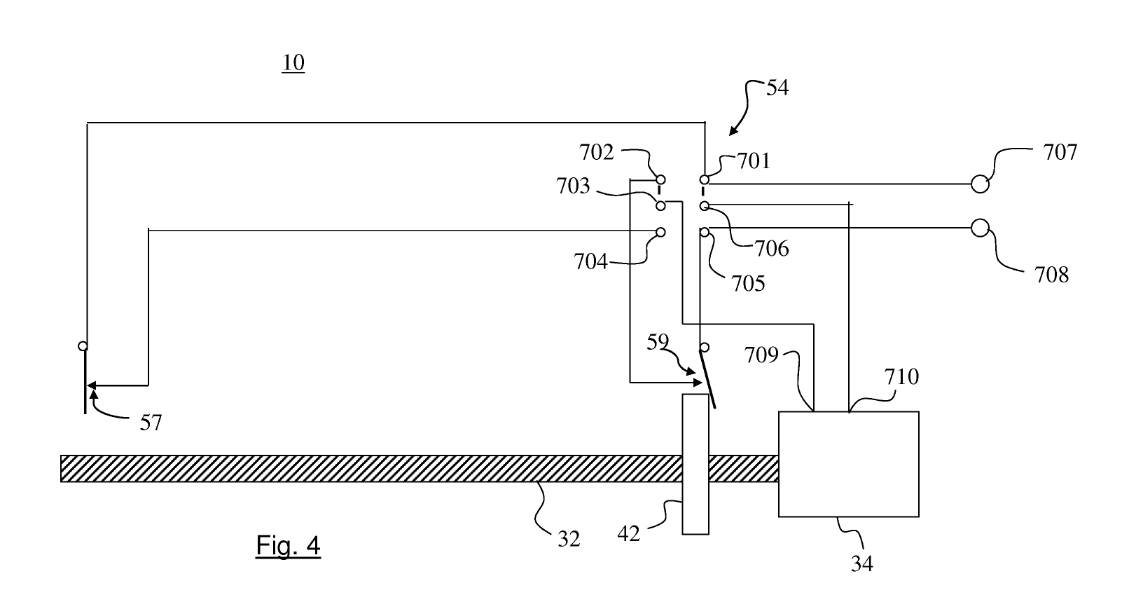

Referring now particularly to FIG. 4, therein is illustrated full rearward movement of the thread follower 42 such that the rear limit switch 59 is engaged and opened. When the rear limit switch 59 is opened the circuit for rearward movement is broken, the motor 34 is de-energized, rotation of the drive shaft 32 ceases and rearward movement of the thread follower 42 (and, likewise, the piston head 48) is discontinued.

Referring now particularly to FIG. 5, therein is illustrated the electrical connection for forward movement of the thread follower 42 (and, therefore, its connected piston head 48). The lowermost set of terminals 705, 704 of the trigger switch 54 are contacted by the middle set of terminals 706, 703 to close a circuit that energizes the motor 34 thereby causing rotation of the drive shaft 32 in a second direction that is opposite the first direction and associated forward movement (the forward stroke) of the thread follower 42 (and the piston 48 connected thereto) as indicated by direction arrow 721. In this circuit arrangement, the polarity of the electricity applied to the motor 34 is reversed, thereby causing the motor 34 to rotate in the second direction. Battery terminal denoted 707 is now connected to motor terminal denoted 709. And battery terminal denoted 708 is now connected to motor terminal denoted 710. The rearward limit switch 59 is inoperable during forward movement of the thread follower 42 because the circuit for that switch 59 is open.

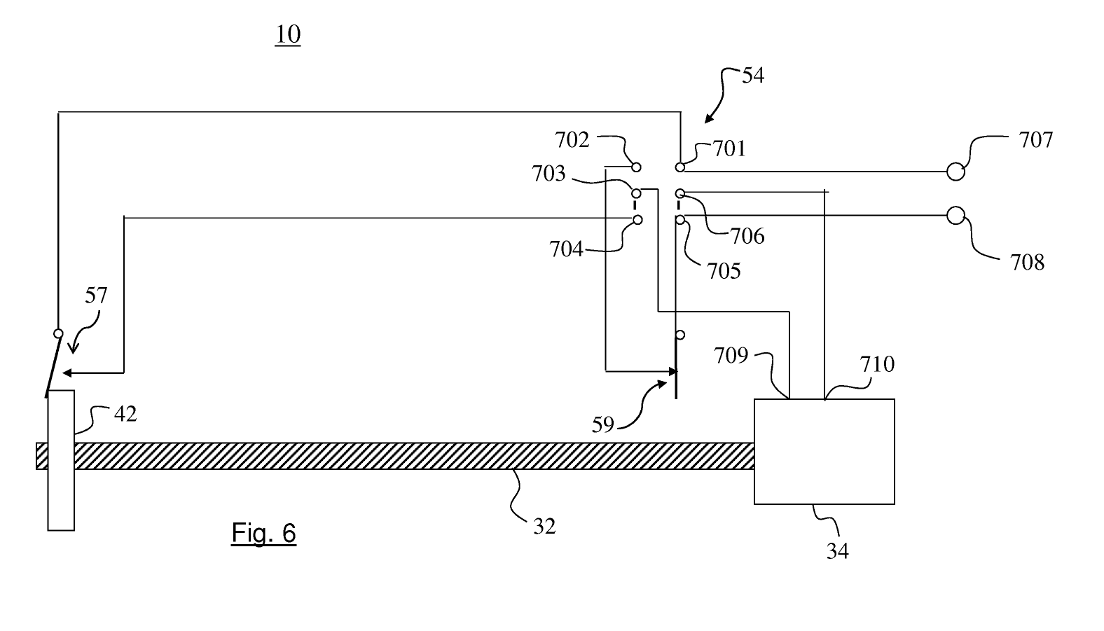

Referring now particularly to FIG. 6, therein is illustrated full forward movement of the thread follower 42 (and the piston head 48 connected thereto) such that the forward limit switch 59 is engaged and opened. When the forward limit switch 57 is opened the circuit is broken, the motor 34 is de-energized, rotation of the drive shaft 32 ceases and forward movement of the thread follower (and attached piston head 48) is discontinued.

Forward limit switch 57 and rear limit switch 59 ensure that the mechanical components of the water gun 10 do not travel beyond or exceed their design parameters. For example, the limit switches 57, 59 ensure that the thread follower 42 and its associated piston head 48 do not over-travel their boundaries. Limit switches 57, 59 define the end-of-travel positions for respective forward and rearward stroke directions. The limit switches ensure that the motor 34 does not send thread follower 42 to an extreme position that could cause the water gun 10 to malfunction. The limit switches 57, 59 also protect against malfunctions such as disengagement of thread follower 42 from the elongated, threaded, drive shaft 32 or impingement of follower 42 against other components of the gun with such force as to cause binding or burnout of the motor 34.

In operation, the water gun 10 of FIGS. 1 through 6 discharges a continuous stream of the fluid content of the piston chamber 24 through discharge aperture 22 during the forward stroke 721 of the piston 48. Fluid may be drawn into the piston chamber 24 by a negative pressure differential created within the chamber 24 during a rearward stroke 720 of the piston head 48. Water may be drawn into the piston chamber 24 by submerging the discharge aperture 22 into a container of water such as a bucket or swimming pool and engaging the rearward movement trigger contacts 701, 702. The rearward stroke and the forward stroke may be terminated manually by releasing the trigger or may be terminated automatically when the piston head 48 engages a respective limit switch 57, 59.

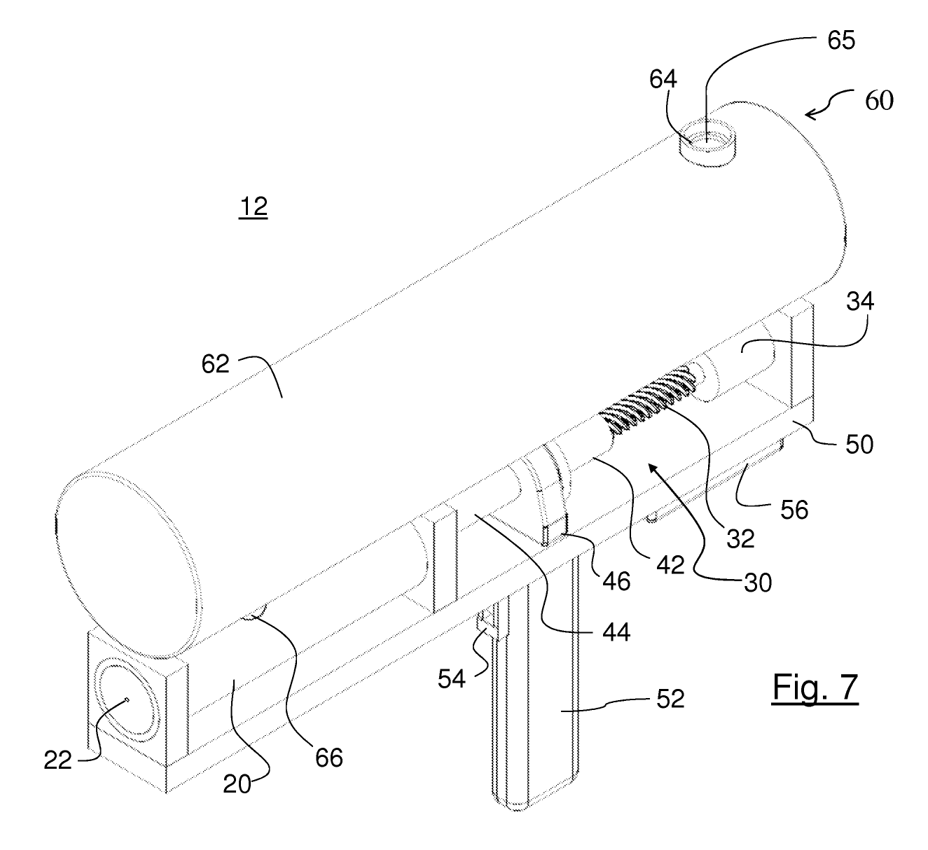

Referring now to FIG. 7, therein is illustrated a toy water gun 12 having an attached reservoir system 60 for storing fluid for the gun 12. The water gun 12 has the same components and numbering therefor as the water gun 10 of FIGS. 1 through 6 plus a reservoir system 60 including associated components. The previously described components of the above-described water gun 10 will not be re-described. The new components will be described. The reservoir system 60 has a housing 62 whose interior (not shown in this view) defines a reservoir chamber. The reservoir housing 62 has a reservoir inlet aperture 64 through which the interior of the reservoir housing 62 may be filled. A one-way valve 65 such as a check valve inhibits flow of fluid outwardly from the reservoir chamber (that is, the interior of the reservoir housing 62). A reservoir outlet conduit 66 connects the reservoir housing 62 to the piston housing 20.

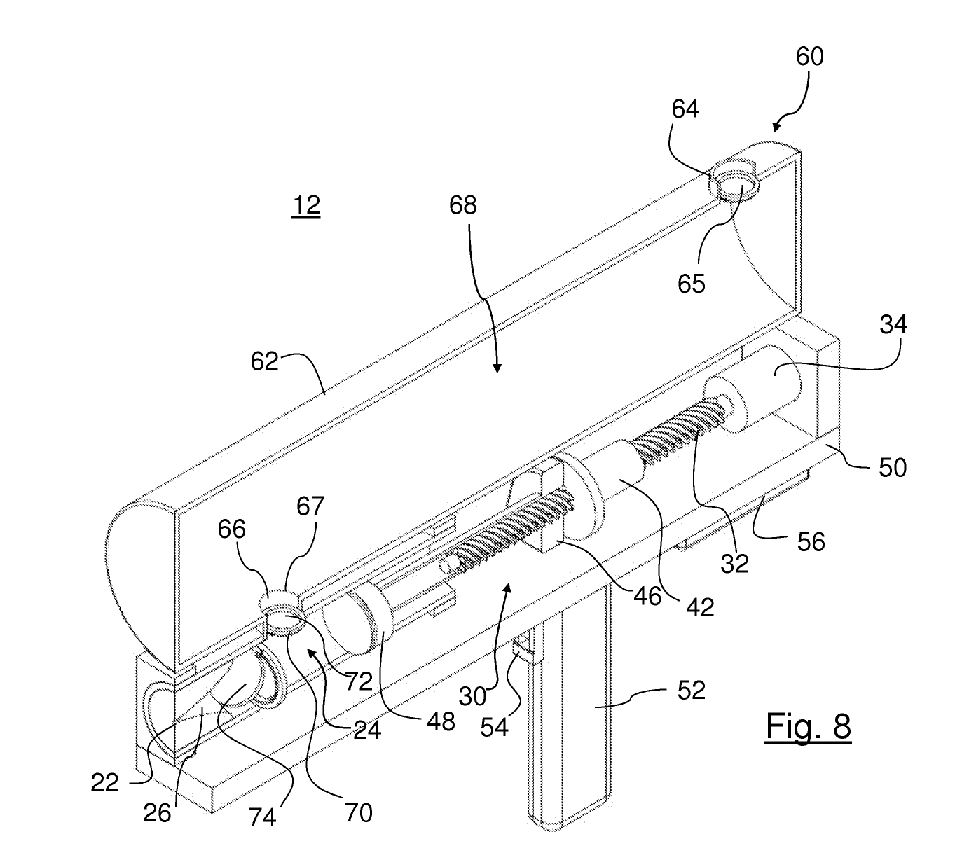

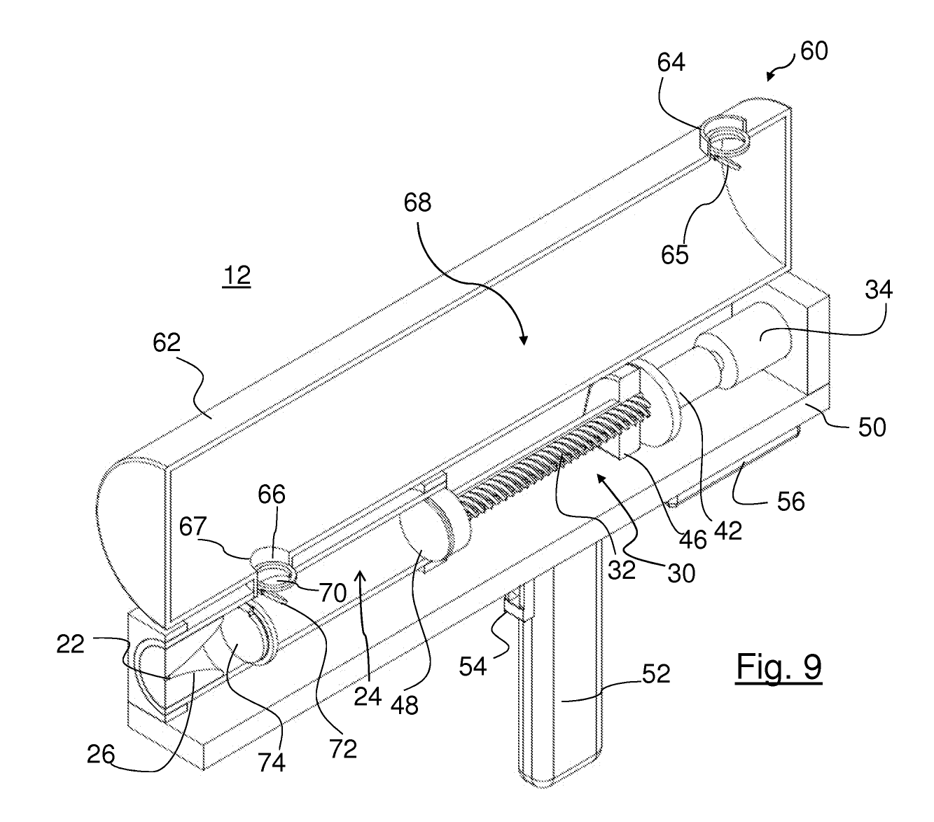

Referring now to FIGS. 8 and 9, therein are shown cut-away views of the toy water gun of FIG. 7. One end of the reservoir outlet conduit 66 terminates at a reservoir outlet port 67 that provides access to the reservoir chamber 68 defined by the reservoir housing 62. The other end of the reservoir outlet conduit 66 terminates at a piston chamber inlet port 70. A one-way, piston inlet valve 72, such as a check valve, disposed at the piston chamber inlet port 70 prevents the flow of fluid from the piston chamber 24 through the reservoir outlet port 66 back into the reservoir chamber 68. A one-way, piston chamber discharge valve 74 is disposed to prevent the flow of fluid from the piston chamber 24 when the piston chamber 24 is being filled under negative pressure.

Referring now particularly to FIG. 8, therein is illustrated the toy water gun 12 of FIG. 7 in a discharge mode. As the piston head 48 moves forwardly, any liquid fluid in the piston chamber 24 is pressurized and any vaporous fluid is compressed. The positive pressure created in the piston chamber 24 closes and substantially seals the one-way, piston chamber inlet valve 72 at the piston chamber inlet port 70 and opens the one-way, piston chamber discharge valve 74 thus permitting fluid to be discharged from the piston chamber 24 through the nozzle 26 and discharge aperture 22. The piston 48 travels forwardly creating positive pressure in the piston chamber 24 until manually or automatically stopped. The contents of piston chamber 24 can be completely or partially discharge under pressure and the water gun 12 is ready to be filled as desired.

Referring now particularly to FIG. 9, therein is illustrated the toy water gun 12 of FIG. 7 in a filling mode. As the piston head 48 moves rearwardly, a negative pressure is created in the piston chamber 24 thereby causing the one-way valve at the anterior end of the piston chamber 24 to close and substantially seal and opening the one-way valve 72 of the piston chamber inlet port 70 thus permitting fluid from the reservoir chamber 68 to flow into the piston chamber 24. The piston head 48 travels rearwardly until manually or automatically stopped. The piston chamber 24 is thus filled and the water gun 12 is ready to be discharged

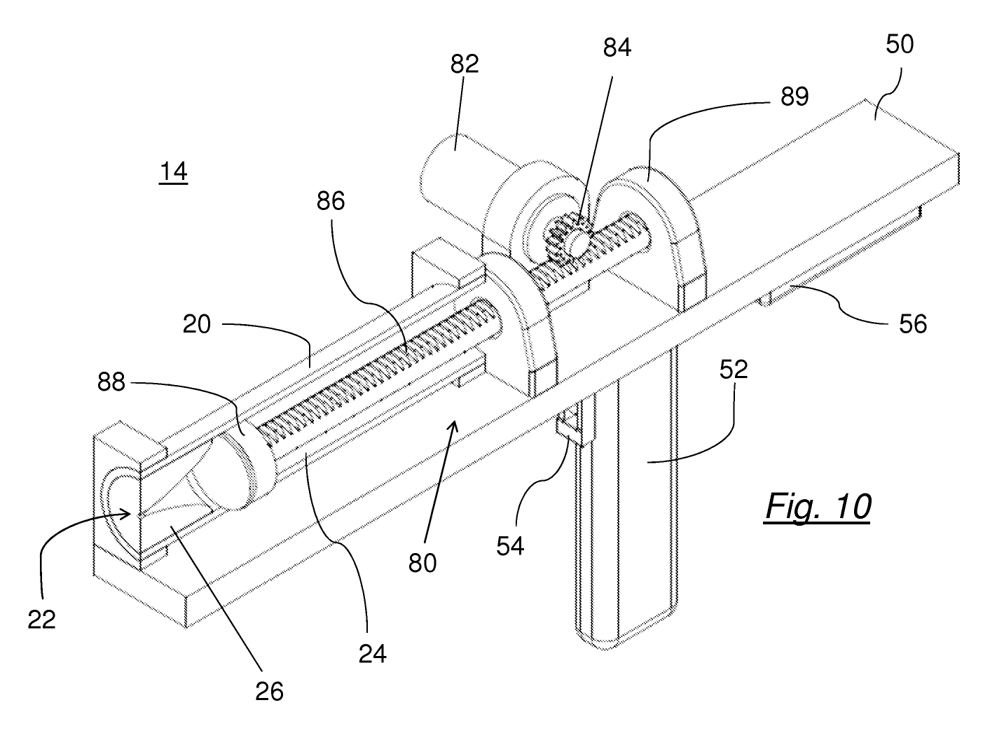

Referring now to FIG. 10, therein is illustrated a toy water gun 14 having a rack-and-pinion-based linear-drive mechanism according to an embodiment of the invention. Many of the components that are a part of the water guns of FIGS. 1 through 9 are also contained in the toy water gun of FIG. 10. Most of these common features are evident and will not be described again. Several that are shown are identified by the same reference numerals. The distinction of the water gun of FIG. 10 lies in the linear-drive mechanism 80. The rack-and-pinion-based linear-drive mechanism comprises a reversible motor 82 that rotates a pinion member 84 that, in turn, is cooperatively engaged with an elongated rack member 86. An anterior end of the rack member 86 terminates in a piston head 88. The rack member is slidably supported by mounting sleeves 87, 89.

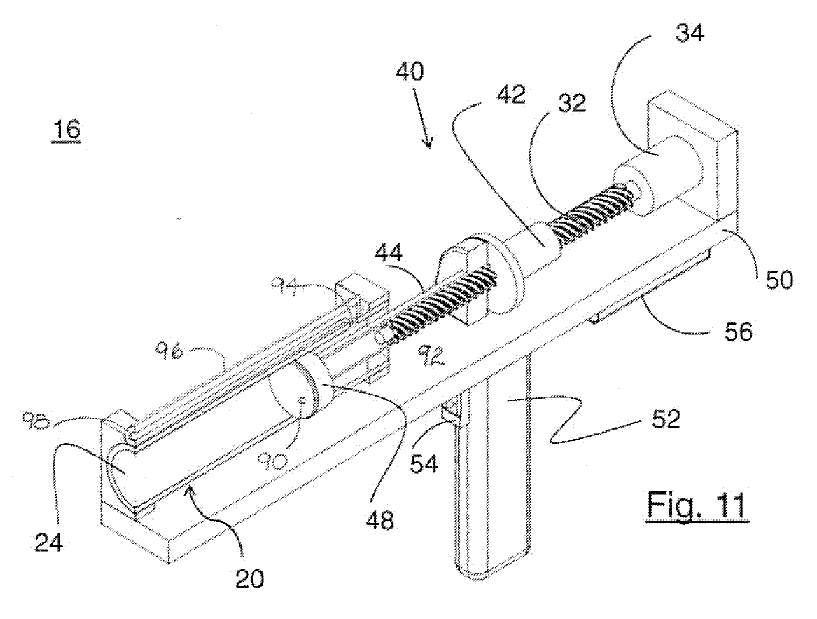

Referring now to FIG. 11, therein is illustrated a toy water gun 16 having a discharge mechanism that is operative during a rearward stroke of the water gun 16 in accordance with an embodiment of the invention. Many of the components that are a part of the water guns of FIGS. 1 through 9 are also contained in the toy water gun of FIG. 11. Most of these common features are evident and will not be described again. Several that are shown are identified by the same reference numerals. The distinction of the water gun of FIG. 11 lies in a structure that facilitates a mode of operation wherein fluid from the piston chamber 24 is discharged through a piston-discharge aperture 90 disposed in the piston head 48. The piston-discharge aperture 90 extends through the piston head 48 providing a pathway for fluid from the piston chamber 24. The posterior end of the piston housing 20 is closed off, such as by a posterior piston chamber seal 92. Thus the operative fluid-encapsulating portion of the piston chamber 24 lies between the posterior piston chamber seal 92 the piston head 48. Fluid may be drawn into the piston chamber 24 through an inlet orifice 94 in the piston housing. The inlet orifice 94 may be an end point of a fluid conduit 96 having a bore 98 defined therethrough. The inlet mechanism comprises the inlet orifice 94 and the inlet conduit 96 and may have a one-way valve (not shown), such as a check valve. Optionally, a reservoir system may be suitably attached.

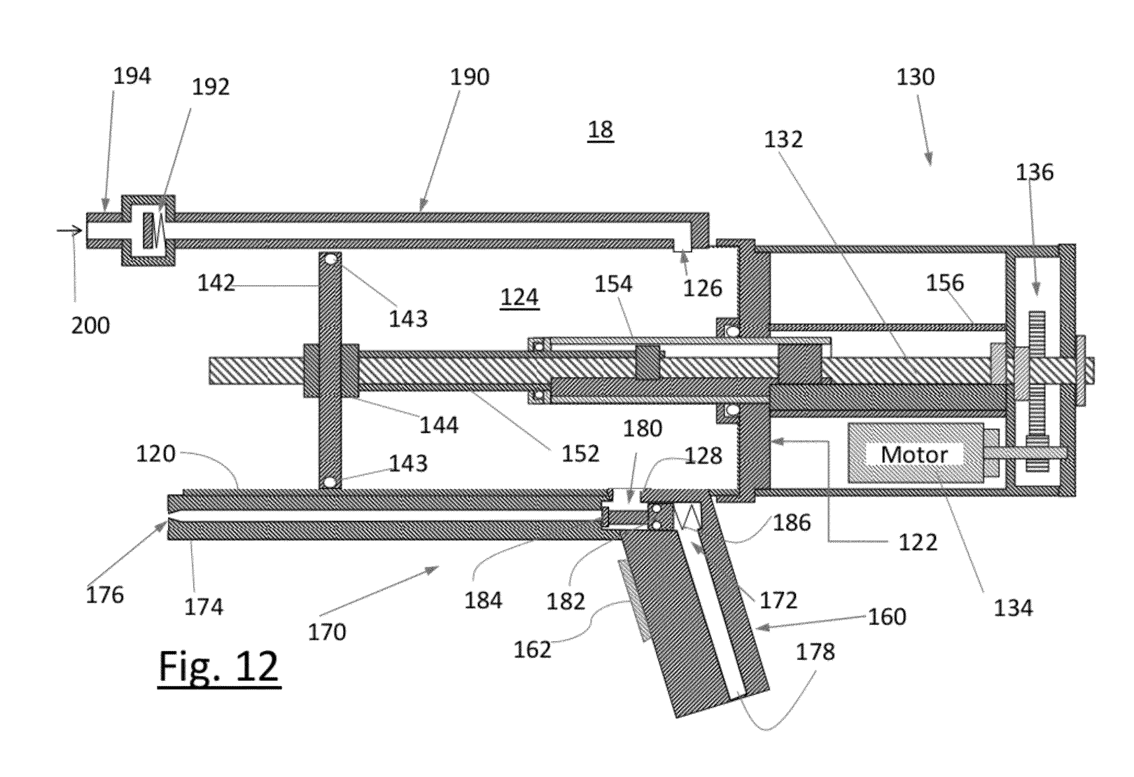

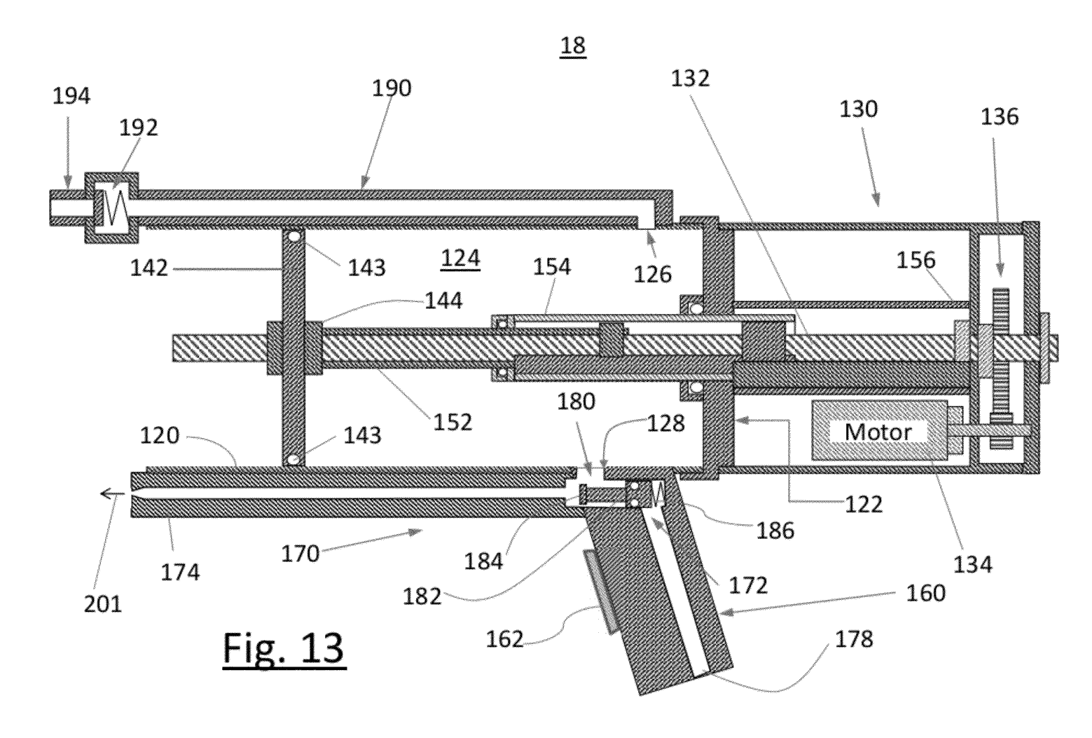

Referring now to FIGS. 12 and 13 simultaneously, therein are shown a toy water gun 18 that discharges fluid during a rearward stroke through a discharge conduit that is external with respect to the piston housing in accordance with an embodiment of the invention. FIGS. 12 and 13 will be discussed together because they differ only in the position of a valve plunger. A piston housing 120 is sealed at a posterior end such as by a posterior housing seal 122. The housing 120 defines a piston chamber 124 and further defines an inlet port 126 and an outlet port 128. The linear-drive mechanism 130 comprises an elongated, threaded, drive shaft 132 that is rotationally driven by a reversible DC motor 134 that is connected to the drive shaft 132 by a gear train 136. A piston head 142 is slidably disposed in the piston chamber 124 centered on the drive shaft 132. O-rings 143 help form a slidable seal. A thread follower 144 interconnects the piston head 142 to the drive shaft 132. The drive shaft 132 is received in and sealed off from the piston chamber by a sleeve arrangement which may be a single component but which, as shown in this embodiment, may be a series of telescoping sleeve members 152, 154, 156. Rotational motion of the thread follower 144 must be prevented so that rotational motion of the drive shaft 132 is converted to translational motion of the piston head 142 to the greatest extent possible. A detent mechanism may be used to inhibit rotational motion of the thread follower 144 and piston head 142 attached thereto. However, in the embodiment of FIGS. 12 and 13, rotational motion of the thread follower 144 and associated piston head 142 is inhibited by the piston sleeve arrangement that inhibits rotational motion of the telescoping sleeves 152, 154, 156 to which the thread follower 144 is affixed. A handle 160 is disposed for holding the water gun 18. More than one handle may be used and the handle may be placed in a variety of suitable locations. A trigger switch 162 for actuating the motor 134 is disposed in the handle for convenience. A discharge mechanism 170 is disposed for release of fluid from the piston chamber 124. The discharge mechanism includes a one-way valve 172, a discharge conduit 174 with discharge opening 176 and a vent 178. The one-way valve 172 comprises a plunger chamber 180 that slidably houses a plunger including a plunger body 182 and a plunger head 184. Referring particularly to FIG. 12 momentarily, a spring 186 biases the plunger body upwardly such that the plunger head 184 is held in place over the outlet port 128 of the piston housing 120. Referring now again to both FIG. 12 and FIG. 13, a filling conduit 190 extends from the inlet port 126 of the piston housing 120. A fill one-way valve 192 is disposed at the end of the filling conduit 190. A filling nozzle 194 may be placed at the end of the filling conduit 190.

In the water gun 18 of FIGS. 12 and 13, both one-way valves 172, 192 maintain the pressure of the contents of the piston chamber 124 until sufficient pressure is initiated to overcome a respective valve 172, 192. To fill the piston chamber 124, the trigger switch 162 is engaged so as to propel the piston head 142 forwardly thereby creating a negative pressure differential that will draw fluid (such as water from a container into which the fill nozzle 194 is immersed) into the piston chamber 124. In FIG. 12, the one-way valve 192 is in an open condition with spring compressed wherein fluid enters, as shown by direction arrow 200, the piston chamber 124. When the piston chamber 124 has been filled, the trigger switch 162 may be actuated so as to move the piston head 142 rearwardly thereby creating a positive pressure differential. When the positive pressure inside the piston chamber 124 reaches a sufficient level to overcome the force of the valve spring 186, the plunger head is pushed away from the outlet port 128 thus allowing fluid to discharge through the discharge conduit 174 in a burst. In FIG. 13, the valve spring 186 of the discharge one-way valve 172 is shown in a compressed condition wherein the valve 172 is open (wherein the valve spring is compressed) permitting fluid to be discharged, as shown by direction arrow 201, from the piston chamber 124. Fluid is impelled in a continuous stream until the chamber 124 is sufficiently emptied or the trigger switch 162 is disengaged.

Many variations and modifications may be made to the above-described embodiments without departing from the scope of the claims. All such modifications, combinations, and variations are included herein by the scope of this disclosure and the following claims.

The invention provides a toy water gun that is capable of quickly and easily propelling a continuous stream of water a substantial distance in a manner that does not require undue exertion by a user, and particularly in a manner that does not require substantial finger or arm exertion by a user. And, further, the toy water gun taught by the invention can be quickly and easily filled with water in preparation for discharge.

1. A toy water gun comprising:
an elongated housing having an anterior end and a posterior end, defining a piston chamber;
a discharge structure in fluid-flow communication with said piston chamber; and
an energizable linear-drive piston mechanism juxtaposed with respect to said elongated housing having a piston assembly including a piston head translatably disposed within said piston chamber for pressurizing said piston chamber;
wherein said energizable linear-drive piston mechanism is selectively operable between anterior translational movement and posterior translational movement of said piston head.

2. The toy water gun of claim 1, said discharge structure comprising a discharge aperture disposed in a closed anterior end of said piston chamber.

3. The toy water gun of claim 2, said discharge structure further comprising a nozzle structure terminating in said discharge aperture.

4. The toy water gun of claim 1, said discharge structure comprising a discharge aperture disposed proximate one of an anterior end and a posterior end of said elongated housing.

5. The toy water gun of claim 1, wherein said energizable linear-drive piston mechanism is disposed proximate said posterior end of said elongated housing.

6. The toy water gun of claim 1, wherein said energizable linear-drive piston mechanism further comprises a rotationally-driven, elongated, threaded drive shaft cooperatively engaged with said piston assembly so as to impart linear motion to said piston head.

7. The toy water gun of claim 6, wherein said rotationally-driven, elongated, threaded drive shaft is cooperatively engaged with said piston assembly by a thread follower.

8. The toy water gun of claim 7, further comprising a detent for inhibiting rotational motion of said thread follower.

9. The water gun of claim 7, wherein said piston head is connected to said thread follower by an elongated piston connecting shaft.

10. The water gun of claim 9, wherein said rotationally-driven elongated, threaded drive shaft is translatably received within said elongated piston connecting shaft.

11. The toy water gun of claim 1, wherein said energizable linear-drive piston mechanism is rotationally driven by an electric motor.

12. The toy water gun of claim 11, further comprising an actuator for said electric motor.

13. The toy water gun of claim 11, wherein said electric motor is reversible.

14. The toy water gun of claim 13, further comprising an actuator for selectively actuating said reversible, electric motor to turn in opposite directions.

15. The toy water gun of claim 1, wherein said energizable linear-drive piston mechanism further comprises a rack member connected with said piston assembly and a rotationally-driven pinion member cooperatively engaged with said rack member.

16. The toy water gun of claim 1, wherein said piston chamber is closed at a posterior end and said discharge structure comprises a piston discharge aperture disposed in said piston head.

17. The toy water gun of claim 1, further comprising an inlet port disposed within said housing for filling said piston chamber.

18. The toy water gun of claim 17, said inlet port further comprising a valve for inhibiting outward flow of fluid.

19. The toy water gun of claim 17, further comprising an inlet conduit extending from said inlet port.

20. The toy water gun of claim 19, said inlet conduit further comprising a valve for inhibiting outward flow of fluid.

21. The toy water gun of claim 17, further comprising a reservoir connected with said inlet port.

22. The toy water gun of claim 21, said reservoir having an inlet aperture for filling.

23. The toy water gun of claim 1, wherein said discharge structure comprises a discharge conduit extending from said housing terminating in a discharge opening.

24. The toy water gun of claim 23, wherein said discharge opening is disposed proximate an anterior end of said elongated housing.

25. The toy water gun of claim 23, said discharge conduit further comprising a normally-closed valve disposed between said housing and said discharge opening operable to open when pressure at said piston chamber exceeds a predetermined level.

26. The toy water gun of claim 25, wherein said normally-closed valve is spring-loaded.

27. The toy water gun of claim 25, wherein said normally-closed valve is vented.

28. The toy water gun of claim 1, wherein said discharge structure is in fluid-flow communication with one of an anterior end and a posterior end of said piston chamber.

29. The toy water gun of claim 1, further comprising an electrical circuit that de-energizes said energizable linear-drive piston mechanism that is in an energized when said piston head travels to at least one predetermined position within said piston chamber.
